(19) United States
(12) Patent Application Publication
(10) Pub. No.: US 2005/0229451 A1
(43) Pub. Date: Oct. 20, 2005

(54) Method and apparatus for parking space advertising

(76) Inventors: Stephen Mullens, San Francisco, CA (US); Teresa McDowell, Albuquerque, NM (US); Kristina Eisenacher, Albuquerque, NM (US); David Crosby, Sharon, MA (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 10/947,559

(22) Filed: Sep. 22, 2004

Related U.S. Application Data
(60) Provisional application No. 60/504,904, filed on Sep. 22, 2003.

(51) Int. Cl. G09F 11/02

(52) U.S. Cl. 40/500

(57) ABSTRACT

This invention relates to outdoor advertising and, more particularly, to methods, systems and apparatus for providing branded parking spaces. The invention includes using a standard parking space as an advertising space that creates an opportunity for advertisers to reach customers with branded messages at a place where they park a vehicle, creating an out-of-home advertising venue. The parking space can have an advertising message applied to it, such as on a sign placed within the parking space, adjacent to the parking space or in an area between two adjacent parking spaces. The advertising message can also be applied to the asphalt or concrete within the parking space, adjacent to the parking space or in an area between two adjacent parking spaces. The advertising message can also be applied to a canopy, overhang or ceiling that is within the parking space, adjacent to the parking space or in an area between two adjacent parking spaces. An agency or organization, such as an advertising media company obtains permission to apply an advertising message to one or more parking spaces. The advertising media company obtains an advertising message from or creates an advertising message for an advertiser, and in exchange for consideration, applies the advertising message to the parking space. The advertising media company can apply the advertising message to the parking space in accordance with a predefined arrangement between the advertising media company and the advertiser. The advertising media company can apply different advertising messages to a given parking space over a period time. The advertising message can be incorporated in a changeable form, such as a sign or an electronic display that is capable of displaying more than one advertising message. The advertising message can be transmitted to an available display device within a vehicle using wireless communication systems.

### CROSS-REFERENCE TO RELATED APPLICATIONS

This application claims the benefit of U.S. Provisional Patent Application Ser. No. 60/504,904, filed on Sep. 22, 2003, the entirety of which is herein incorporated by reference.

### STATEMENT REGARDING FEDERALLY SPONSORED RESEARCH

Not Applicable

### REFERENCE TO MICROFICHE APPENDIX

Not Applicable

### BACKGROUND OF THE INVENTION

This invention relates to outdoor advertising and, more particularly, to methods, systems and apparatus for providing advertising in parking spaces, including branded parking spaces. The invention includes using a parking space as a revenue generating advertising space that creates an opportunity for advertisers to reach customers with branded messages at a place where they park a vehicle, creating an out-of-home advertising venue.

Current prior art parking spaces include parking spaces that are used by customers to park their vehicles prior to entering a store. Some parking spaces are termed designated parking spaces, including handicapped parking and VIP parking spaces. Another example of a designated parking space includes, for example, so called “stork parking” or “MommyParking” which is basically designated parking for pregnant women and mothers with small children. These parking spaces typically include a sign with a stork insignia or emblem and are provide by the retailer in a location close to the entrance to the store or mall. The retailer may also provide their name on the sign or a message indicating that the retailer is providing the designated parking for the safety and convenience of pregnant women and mothers with small children.

MommyParking is designated parking for drivers with children under age six. The parking spaces are located close to the entrance of the store so that they are convenient to the mothers and drivers with small children so that they reduce the safety concerns for the mother or driver who is trying to navigate from the parking space to the store with children and packages in tow. They are also located under the lights of the parking lot so that they can be seen at night for safety concerns and they are in plain view of the entrance of the store and are also located close to the cart returns.

It is also known in parking lots to provide instructional signs that may be adjacent to parking spaces to direct customers to the entrance to a store or mall or to direct customers to the parking lot exit. Further, there is metered parking where you pay to park in a space for a period of time, which may include signage directed to the cost of parking as well as any limitations in time or type of vehicle that can be parked in the spot.

Separate and apart from parking lots, well known advertising mediums include out-of-home advertising mediums such as billboards, bus stops, retail store window displays, etc. These are traditionally aimed at capturing the customer's attention with branded messages by the advertiser hoping to catch the attention of the customer regarding the advertiser's brands, products or services. There can be billboards placed strategically around store locations and are not associated with a specific parking spot. Advertisements can be placed on the sides of buildings that face the retail location in the parking lots and the advertising can be either on or behind the store windows that face the parking lots and parking spaces.

There is intense competition among advertisers to reach their customers with branded messages at or near the point of purchase. However, prior art methods have been limited to the use of conventional billboards and signage. Accordingly, it is an object of this invention to an improved method and apparatus for enabling advertisers to advertise their brands, products and services to their customers;

It is a further object of the invention to provide advertising agencies, media companies, and other business entities with an improved method and system for generating revenue from advertising the brands, products and services of others.

### SUMMARY OF THE INVENTION

The parking space advertising according to the present invention allows advertisers to reach their customers by displaying advertising messages to customers directly in the parking space where the customer parks their car, such as prior to entering the store. The present invention also includes a method and system for an agency or organization (such as an advertising media company) to offer and sell or lease advertising space or signage in or adjacent to a parking space or a group of parking spaces.

In accordance with the invention, a parking space can be provided with indicia that include an advertisement for the goods or services or brand image of an organization. The indicia can also designate the parking space as being assigned or reserved for a specific demographic group of people, such as pregnant women, parents with small children or the target of the advertisement. The indicia can be provided on signage that is located within the parking space, the area immediately adjacent to the parking space or the area between two adjacent parking spaces. The placement and arrangement of the indicia can provide the indication that the advertisement is directed to a single parking space. The placement and arrangement of the indicia can provide the indication that the advertisement is directed to a group of adjacent parking spaces. The indicia can be placed on conventional signposts and sign carrying structures. The indicia can be placed on custom designed display structures along one or more sides of a parking space. The indicia can be placed on the asphalt or concrete within the parking space, whereby the customer parks their car on the indicia or a portion of the indicia. The indicia can be placed on the asphalt or concrete that is located within the parking space, the area immediately adjacent to the parking space or the area between two adjacent parking spaces. The indicia can be placed on a canopy, overhang or the ceiling that is located within the parking space, the area immediately adjacent to the parking space or the area between two adjacent parking spaces. The parking space can include a dispenser for dispensing coupons or other promotional materials for the customer. A drop box or kiosk could be provided to enable a customer to provide information to the advertiser, for example, in order to enter a contest or obtain more information about the advertised product or service. The indicia that are applied to the parking space can be changed over a period time. The indicia can be incorporated in a changeable sign, such as a mechanical with removable lettering or symbols or an electronic sign that is capable of displaying more than one advertising message. The electronic sign can present several advertising messages at the same time. The electronic sign can present several advertising messages sequentially during a given period of time, such as the time that the sign is within the view of customers parking their vehicle or walking past the parking space. The electronic sign can display a number or password that enables a customer to obtain a benefit, such as, a discount or rebate on purchases.

In accordance with the invention, an agency or organization, such as an advertising media company, can enter into an agreement with the owner or possessor of the parking spaces whether they be the landlord or property owner or the retailers themselves to allow the media company to place the advertising displays directly in or adjacent to the parking spaces. This agreement can be structured in several ways. One way is that the media company can rent or lease the parking spaces from the owner, on a periodic basis, such as monthly or quarterly or yearly lease or rent agreement. Another agreement between the two parties can be one of a revenue sharing agreement whereas the media company shares with the owner of the parking spaces, part of the revenue that the media company earns from the advertisers in exchange for allowing the media company to provide the advertisements in or adjacent to the parking spaces. Further, the owner or possessor of the parking spaces can allow the media company to provide the advertisements in or adjacent to the parking spaces in exchange for the media company accepting the obligation to provide upkeep and maintenance of the parking spaces. Once the agreement has been finalized between the media company and the owner or possessor of the parking space, the media company then installs the advertising displays in each parking space or group of parking spaces. Once those displays have been installed, the media company can then charge advertisers a fee to place their advertisements on those displays. The specific fees can be determined by the media company. The fees paid by the advertisers can be based on a period of time that the advertisement is display, such as, weekly, monthly or yearly. In the case of changeable signage, fee can be based upon the number of times the advertisement is displayed over a given period of time. In addition, the fees can vary depending on the time of the day the advertisement is display, for example the fee for advertising during peak shopping times can be greater than the fee for advertising very late at night or early in the morning.

Once the fee arrangement between the media company and the advertiser has been determined, the media company creates the advertisement and puts the advertisement in the parking spaces. The media company can also be responsible for the maintenance and upkeep of those advertisements and advertising displays. For example, if they were to be knocked over by a car or if they were to be defaced or if they were to fade by the sun, the media company would be responsible to keep those advertisements in good condition. This maintenance aspect of the business can be the responsibility of a third party under an agreement with the media company.

### BRIEF DESCRIPTION OF THE DRAWINGS

The foregoing and other objects of this invention, the various features thereof, as well as the invention itself, may be more fully understood from the following description, when read together with the accompanying drawings in which:

FIG. 1 is a diagrammatic view of one embodiment of the present invention;

FIG. 2 is a diagrammatic view of an embodiment of the present invention;

FIG. 3 is a diagrammatic view of an embodiment of the present invention;

FIG. 4 is a diagrammatic view of an embodiment of the present invention;

FIG. 5 is a diagrammatic view of an embodiment of the present invention; and

FIG. 6 is a diagrammatic view of a flowchart of a process in accordance with the present invention.

### DETAILED DESCRIPTION OF THE PREFERRED EMBODIMENTS

The present invention is directed to associating an advertisement with a parking space or a group of parking spaces. The invention is also directed to a method and system through which an organization or business entity can provide advertisements associated with a single parking space or a group of parking spaces.

In accordance with the present invention, a parking space or group of parking spaces are provided with advertisements. The advertisements can take the form of a notice designed to attract public attention in order to promote a brand or a product or service sold under a brand or trademark. The placement and arrangement of the advertisement can provide the indication that the advertisement is directed to a single parking space or a group of parking spaces.

In general, a parking space is a physical location designated for parking a vehicle. The physical dimensions of the advertising parking space according to the invention can be the same as any parking space that currently exists. The size of the parking space can vary depending upon the size of the intended vehicle to be parked there. Preferably, the size of the indicia and other elements of the advertisement can be scaled appropriately to fit within the space provided and the size range being subject to the direction of the advertiser (brand owner, product or service provider), the parking space owner or possessor, the media company or advertising agency or organization or business entity, and possibly, the laws of the locale.

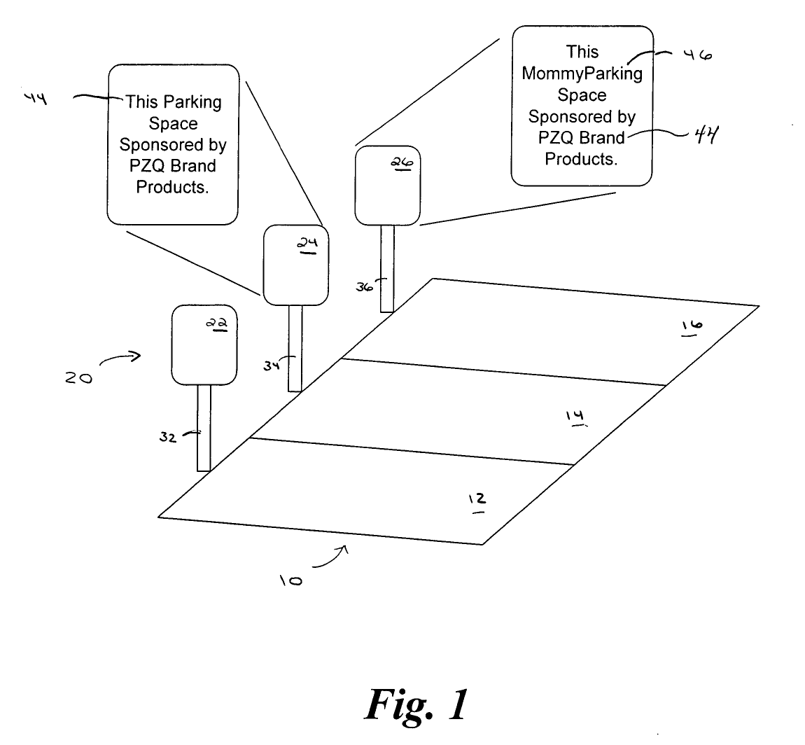

FIGS. 1-5 show various embodiments of the present invention. FIG. 1 shows a group of adjacent advertising parking spaces 10 and a group of advertising signs 20 according to the present invention. Each of the parking spaces 12, 14, 16 includes an advertising sign 22, 24, 26, mounted on a post 32, 34, 36. A sign can have indicia of an advertising message identifying a brand 44, such as shown on sign 24. Alternatively, a sign can have both indicia of an advertising message identifying a brand 44 and indicia that the parking space is designated or reserved for a particular population or demographic group 46, such as shown on sign 26. Each of the signs 22, 24, and 26 can have the same advertising message 44, such as shown on signs 24 and 26, or each of the signs can have a different advertising message.

Existing parking spaces can be converted to advertising parking spaces according to the invention by placing advertising display structures within the parking space at the front of the parking space and/or at the sides of the parking space and positioned in a way that the passengers of the vehicle can see the advertising messages. Preferably, the advertising messages can be positioned at the eye height of the intended consumer as they look out the front windshield of the automobile or out the sides of the side windows of the automobile.

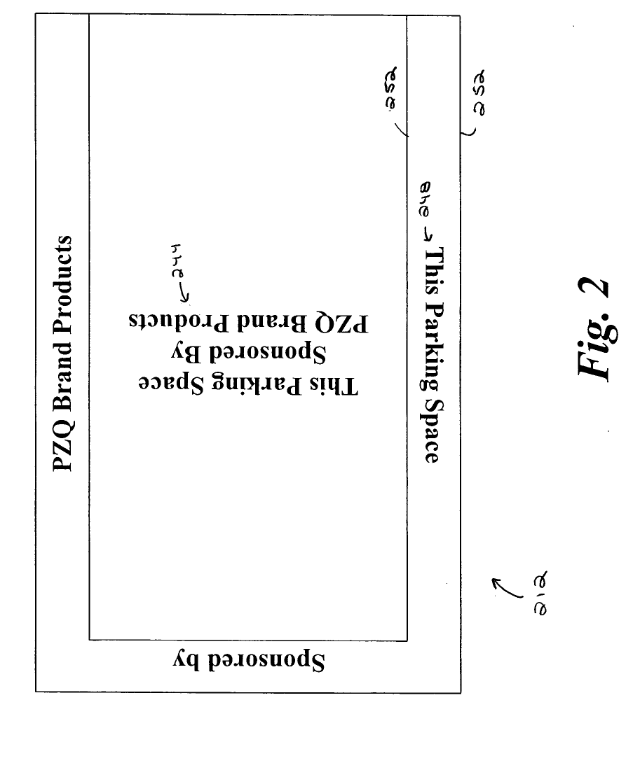

Existing parking spaces can be converted to advertising parking spaces according to the invention by applying the advertisements to the surfaces of the parking space. For example, the pavement of the parking space can be provided with advertisements so that as the driver pulls into the parking space, there printed on the asphalt or on the concrete, on the surface of the parking space is the advertisers message. FIG. 2 shows an advertising parking space 212 according to the present invention having advertisements 244 and 248 applied to the pavement of the parking space. In the embodiment shown, the advertisement 244 can be painted directly on to the surface (e.g. the asphalt or concrete) of the parking space 212 or a sign can be affixed to the surface. Alternatively, the sign can be enclosed in a protective housing that is affixed to the surface of the parking space 212. An advertisement 248 can also be provided on the lines 252 that demark the parking space 212. Similarly, the advertisement 248 can be painted on the lines 252 or embodied in a sign or other structure affixed to the line or the approximate location where the line 252 might be.

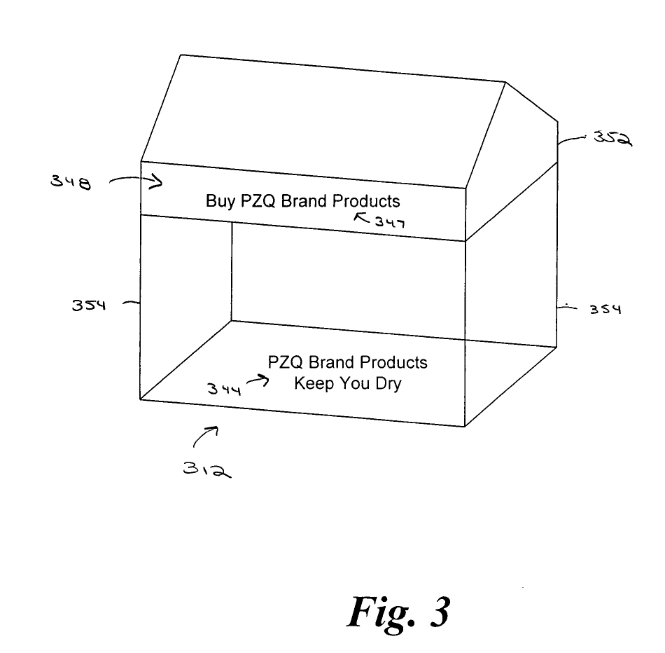

FIG. 3 shows an advertising parking space 312 according to the present invention having an advertisement 344 located on the surface of the parking space and an overhead structure 352, supported by posts 354, also providing one or more surfaces for advertisements 348. The overhead structure 352 can be a freestanding structure, such as a tent or canopy or it can extend from an existing structure, such as an awning or carport (not shown) and can extend over one or more parking spaces. In this embodiment, one or more advertisements 347 can be provided inside as well as outside of the overhead structure 352. The advertisements can also be provided on the support posts 354. In this embodiment of the invention, the advertisement can include a reference to the benefits provided by the overhead structure, such as providing shelter from the rain so a customer can load and unload their packages without getting wet or providing shelter from the heat to shade the car and keep it cool in hot weather. In addition, the overhead structure can provide additional lighting for the convenience and safety of the customer at night.

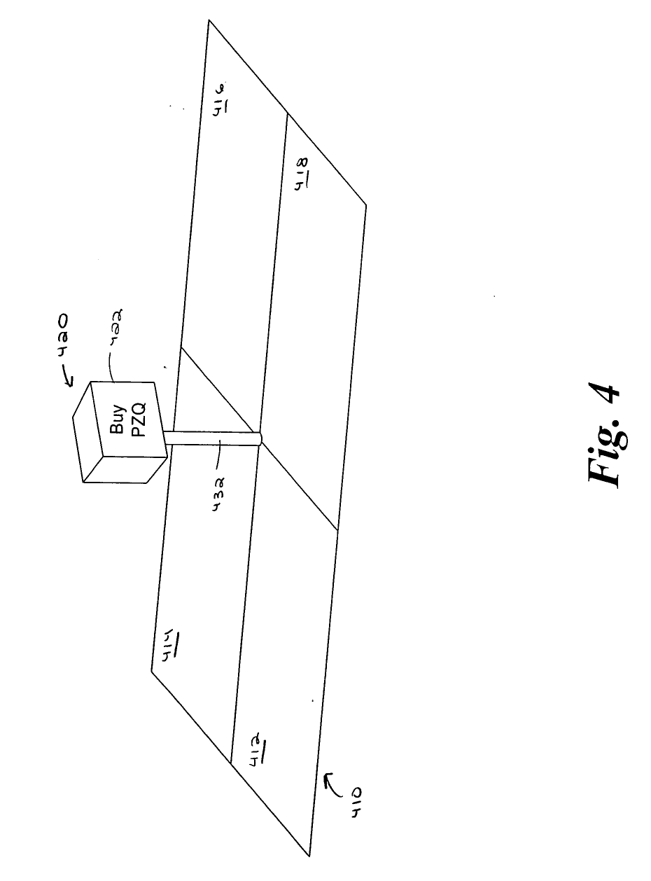

FIG. 4 shows a group of adjacent advertising parking spaces 410 and an advertising display 420 according to the present invention. In this embodiment, each of the adjacent parking spaces 412, 414, 416, 418 is directly adjacent to another parking space either along a common side or at one corner. In this embodiment, a multi-faceted sign display 422 is provided on a post 432. Each of the faces of the sign display 422 is directed to one of the parking spaces 412, 414, 416, 418 and each face can have the same advertisement or different advertisements. The multi-facet sign display 422 can be mounted on an automated mechanism that automatically rotates the multi-facet sign display, each continuously (preferably at a very slow speed) or periodically (preferably in 90 degree increments). Alternatively, sign display 422 can be backlit from inside so as to illuminate the advertisement in dim light or at night. Alternatively, sign display 422 can include one or more electronic signs that allow for the display of advertisements in the form of text messages and/or graphics under the control of a program controller or a computer. The advertisements can change over time, either periodically move from one facet to another or be changed according to a preprogrammed sequence.

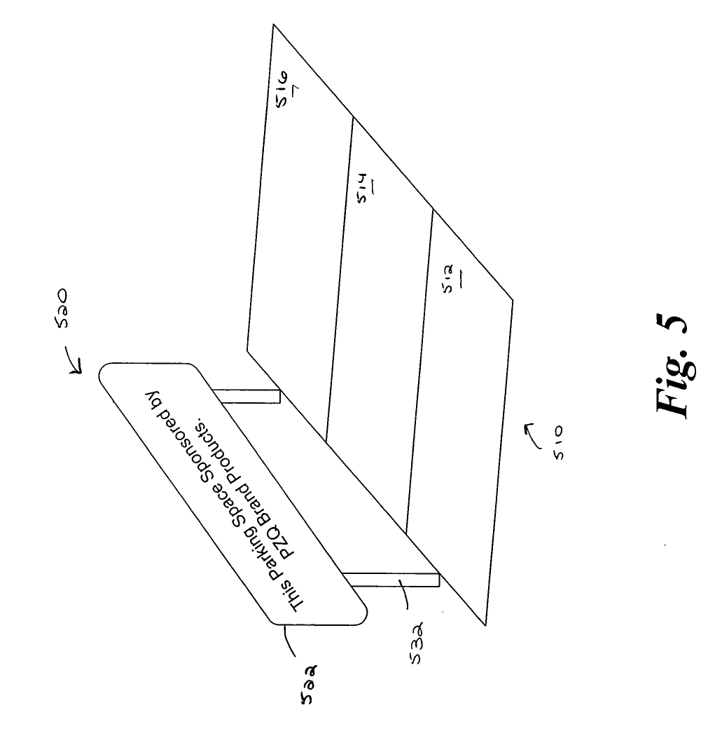

FIG. 5 shows a group of adjacent advertising parking spaces 510 and an advertising display 520 according to the present invention. In this embodiment, each of the adjacent parking spaces 512, 514, 516 is directly adjacent to another advertising parking space and the advertising display 520 extends directly in front of each of them. The advertising display 520 can include a sign 522 supported by one or more posts 532 positioned directly adjacent to the common side of one or more of the advertising parking spaces 512, 514, 516.

In accordance with the invention, the advertising displays 20, 420, 520 do not need to be positioned within the advertising parking space 10, 410 510, the advertising displays 20, 420, 520 can be positioned in the space between two or more parking spaces. For example, it is known that a walkway or landscaped area may occupy the space between parking spaces. In accordance with the invention, it is not necessary for the advertising display to be located within or directly adjacent to the parking space. Preferably, the advertising display can be located in the space between the parking spaces, permitting the customer to open their trunk and car doors without interference from the advertising display. Preferably, the advertising display is decidedly closer to one parking space which is intended to be the primary target of the advertisement and the best view of the advertisement is chosen to be approximately where the primary target of the advertisement would be when they park their car in the advertising parking space.

Where the advertising parking space is provided with electronic signage, sensors can be employed to detect when a vehicle is being parked in the parking space. Based upon what the sensors detect, an advertisement can be selected based upon information provided by the sensors. In one embodiment, the sensor can detect the presence of a vehicle (or a person) such that the advertisement is only displayed when the sensor, for example, detects heat or motion and then turns itself off to conserve energy. Alternatively, based upon other information detected by the sensors (such as size, weight, height of the vehicle or the occupants thereof) under program control a specific advertisement or type of advertisement is select. For example, where a minivan is detected, an advertisement intended for parents with small children is selected over an advertisement for a single adult, such as where a two-seat or two-door car is detected. Through the use of wireless technologies, such as blue tooth, short and mobile messaging services (e.g., SMS and MMS) and other wireless communication technologies, the advertising displays can be enabled to get information directly about the vehicle and/or it occupants in order to more appropriately select one or more advertisements.

In vehicles equipped with video display monitors, such as part of the dashboard, suspended from the ceiling or on the back of the passenger seats, in accordance with the present invention, the parking space can be provided with a wireless signal (such as by a local or remote transmitter), from for example, a blue tooth, short and mobile messaging services (e.g., SMS and MMS) and other wireless communication system, that transmits one or more advertisements to be presented on the video display in the vehicle as the vehicle is parked in the parking space. In this embodiment, an advertising display sign such as those shown in FIGS. 1-5 can optionally be provided in addition the electronic advertisement provide by the vehicles internal video display. In one embodiment, an antenna, used to transmit the advertisements, can be mounted on and optionally hidden or partially obscured by the advertising display sign.

The parking space can be provided with a dispensing display that provides brochures or additional information about the product or service being advertised or provide coupons or samples. The dispenser can include sensors that limit the number of coupons or samples dispensed for each vehicle parked in the parking spot and as function of time (e.g. dispensing limited to 2 units per car parked and/or 5 units per hour). The parking space can be provided with a drop box or kiosk that enables a customer to provide information to the advertiser, for example, to request information, and have a sales person contact them, enter into a contest or take a survey. The parking space advertising display can also provide the customer with a number or a password that enables that customer to obtain additional promotional benefits, such as discounts or coupons or samples when they shop in a particular store.

The actual advertising space display structures can vary depending on the requirements of the individual parking spaces. For instance, one store may prefer a specific design because it looks better with their storefronts. For example, one supermarket chain may prefer structures painted in red and designed in a shape resembles the architecture of their storefront. Preferably, all of these structures have the ability to change the advertisements relatively easy.

In one embodiment, the advertising display signs are constructed similarly to existing and traditional industry standard road signage. Preferably the advertising display sign includes a post structure that is either sunken into the concrete or asphalt, or anchored in a heavy (for example concrete filled) base and a sign, such as a rectangular or round sign, removably affixed to that post by one or more bolts or other removable hardware. The sign can be constructed of almost any material, preferably the sign is made of aluminum, metal or plastic and designed to be durable and weather the elements. Preferably the advertisement is placed on the face of the sign and takes the form of the decal that is in full color on out-of-home media standard material that is used for billboards and such. The advertisement can be printed on the decal and the decal can be provided with an adhesive back that adheres to the face of that sign. The decal can be removed using a simple tool or a solvent and replaced with a new advertisement and changed as often as needed. In addition, the actual sign itself that the decal is adhered to can be printed and customized for the specific retailer, advertiser, media company, organization or business entity. For instance, if this display structure is installed in a parking space at PZQ's Supermarket, the sign can say (have printed thereon) “Compliments of PZQ's” and the decal can be attached to the face of that sign. Alternatively, the sign can say (have printed thereon) “Compliments of PDQ Cola.”

In another embodiment, the display structure design can be similar the first one I just described but instead of the advertisement being printed on a decal that has been adhered to the face of the sign, the advertisement can be printed on a decal and the decal can be adhered to a separate metal or plastic advertising plate that is then attached to the face of the sign. The separate metal or plastic advertising plate can be attached to the face of the sign using conventional fasters such as bolts, screws or pins, or it can be secured in an enclosure that may or may not have a protective window. The advertising plate can be inserted from behind so that it shows through that window on the face and one could replace the advertisement by simply replacing the advertising plate with a new advertising plate.

Another version of the advertising display sign can take the form of a relatively flat display case, such as a case that is a custom designed to hold advertising plates. The display case can include a frame or enclosure constructed from well-known materials, such as aluminum, plastic or steel, that can be connected to or attached to the asphalt or concrete. The advertisement can be printed traditionally on regular paper using traditional printing processes very much like you would print a magazine advertisement and that printed advertisement is inserted into the case. The display case can be is relatively flat and have a clear (Plexiglas or plastic) face on it so that you can see through the face into the advertisement. The display case can protect the advertisement from the weather and by providing a removable side whereby the advertisement can be easily removed and replaced with another advertisement.

Preferably, the advertising display structure can include a 7 ft. high, 2⅜ inch post embedded into the concrete or asphalt of the parking space. At the top of the 7 ft. post ban be attached an 18 inch diameter round sign with the insignia of the mommy parking which can include a illustration symbol of a woman with a child in hand, an infant in hand and an adolescent in tow. Located directly below this round sign can be a rectangular sign that can be 16 inches wide by 24 inches tall. Attached to this 16×24 inch sign can be an adhesive back decal advertisement. The signpost and the signs can be painted (such as blue and yellow) in the brand colors for mommy parking or the advertiser. In addition, printed on the face of the 1 6×24 inch sign can be a designated parking descriptor that says parking for drivers with kids under age 6. Also printed on the 16×24 inch sign can be a description and recognition of one or more sponsors such as the retail store that is providing the parking spaces and the company or brand that are the advertisers. This advertising display structure can be located centered, directly at the front of the parking space

In another embodiment, the present invention can include a railing structure located at or adjacent to one or both of the sides of the parking space that holds the display structures. In addition, these advertising displays can be connected to the concrete floor or existing structural members and dividers between the parking spaces, such as, the structures that separate parking spaces in underground parking structures.

In another embodiment, the advertisements can be placed on flags that are associated with a parking space. The flags can be attached to flag poles or ropes that are positioned adjacent to the advertising parking spaces.

In another embodiment, the advertising parking space can be an oversized parking space that is wider than most parking spaces (similar to a handicap parking space) and has room on one or both sides of the space for a mother with children to safely get the children and the strollers out of the car without impeding upon the other adjacent parking space.

In another embodiment, one or more parking spaces can be designated or reserved for specific populations or demographic groups and can be marked accordingly. This allows advertisers to target specific customer populations more effectively with their advertising messages and programs, population such as mothers, children, families, seniors, VIP's, employees, contest winners, policemen, firemen, doctors, clergy, etc as well as for customers with special purposes such as time limit (for example, 15 minute parking) or carry-out parking or pick-up or drop-off parking.

The invention is also directed to a method and system for managing how the advertisements get associated with a particular parking space or group of spaces and how compensation or value is distributed in compensation for the service provided. In one embodiment of the invention, an organization, such as an advertising media company, that sells space to an advertiser (a company having a product or service to promote). The advertising media company enters into an agreement to place (or allow the advertiser) to place advertisements on signs or other places associated with one or more parking spaces. The advertiser provides the advertising media company compensation or value in exchange for allowing the advertiser to use the advertising space and/or for installing the advertisements at the agreed number of parking spaces.

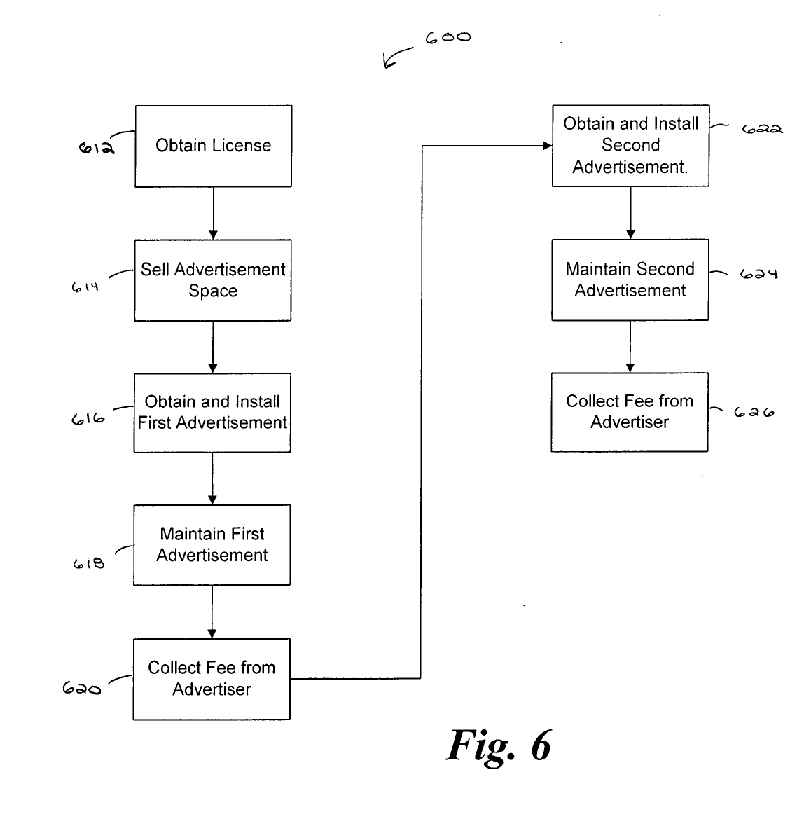

FIG. 6 shows a flow diagram of a method 600 according to the invention. If the advertising media company does not already have the right to put advertisements in parking spaces, the advertising media company can first obtain permission or a license to put advertisements in parking spaces from the owner of the property, 612. After obtaining the license, the advertising media company offers for sale and sells advertisement space in one or more parking spaces to an advertiser. The advertising media company and the advertiser enter into an arrangement whereby the advertising media company will allow the advertiser's advertisements to be displayed in association with one or more parking spaces, 614. The advertising media company obtains from the advertiser the content of the advertisement and installs that content according to the directions of the advertiser at one or more parking spaces, 616. The advertising media company can also, optionally, undertake to maintain the parking spaces and the advertisements, 618. The advertiser provides the advertising media company with the value or consideration, such as a fee, for displaying the advertisement or allowing to the advertisements to be displayed, 620. The advertising media company can collect a fee for displaying the advertisement or allowing to the advertisements to be displayed for a specific time period, for example, the advertising media company can be paid a fee on a monthly or quarterly basis. That fee can be a function of the number of parking spaces or the number of advertisements that are displayed over a given period of time. At a later point in time, the advertiser may ask for additional advertisements to be displayed or change the content or quantity of its first advertisement, 622. The advertising media company can obtain and install the new content 622, and optionally, maintain the advertising displays 624 and collect additional fees, 626. Alternatively, the advertiser could also enter into subsequent agreements with the advertising media company and the process steps 614, 616, 618 and 620 could be repeated many times. In addition, the steps shown in FIG. 6 do not need to be followed in the order shown. For example, the advertiser could provide the media company with value or consideration, as a fee, for allowing the advertisement to be displayed 620 prior to the advertisement being displayed 616.

In accordance with the invention, the organization that sells or rents the advertising space, the advertising media company in FIG. 6 above, need not be an advertising media company. The owner of the parking lot or parking space, the retail store or other lessee or renter of the property could act as the advertising media company in the above embodiment. In addition, the organization that sells or rents the advertising space can be the same business entity or a related business entity to the advertiser, in which case, the fees collected or consideration exchanged may be reflected in the transfer of monies between accounts or not reflected in accounting system at all.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

1. A branded parking space comprising:
a parking space for parking a vehicle and
a sign located adjacent to said parking space, said sign including an advertising message including an identification of a brand and indicia indicating that the parking space is designated for a predefined demographic group that that is a target of the advertising message.

2. The branded parking space of claim 1 wherein said sign is mounted on a post adjacent to said parking space.

3. The branded parking space of claim 1 wherein said sign is a multifaceted sign including a plurality of advertising messages.

4. The branded parking space of claim 1 wherein said sign is located adjacent a plurality parking spaces.

5. The branded parking space of claim 1 wherein said predefined demographic group includes pregnant women.

6. The branded parking space of claim 1 wherein said predefined demographic group includes parents with children.

7. The branded parking space of claim 1 wherein said predefined demographic group includes senior citizens.

8. A method comprising:
providing a branded parking space, said branded parking space comprising a sign located adjacent to said parking space, said sign including an advertising message having an identification of a brand, and
receiving a fee for providing said branded parking space.

9. The method of claim 8 further comprising obtaining a right to install an advertising message including an identification of a brand in a location adjacent to a parking space;

10. The method of claim 8 further comprising obtaining an advertising message including an identification of a brand from a third party.

11. The method of claim 8 further comprising creating an advertising message including an identification of a brand on behalf of a third party.

12. The method of claim 8 further comprising installing said sign at a location adjacent to said parking space.

13. The method of claim 8 wherein said branded parking space is in the possession of a possessor and a portion of said fee received is paid to said possessor.

14. The method of claim 8 further comprising changing said advertising message.

15. The method of claim 8 further comprising maintaining said sign.

16. A method comprising:
obtaining a right to install an advertising message including an identification of a brand in a location adjacent to a parking space;
obtaining an advertising message from a third party;
installing said advertising message in said location adjacent to a parking space; and
receiving a fee from said third party for installing said advertising message in said location adjacent said parking space.

17. A branded parking space comprising
a space for parking a vehicle;
a sign located adjacent said space, said sign including indicia indicating that the parking space is designated for a mothers with children and an advertising message having an identification of a brand that directed to mothers with children.
